(19) United States
(12) Patent Application Publication
(10) Pub. No.: US 2025/0317276 A1
(43) Pub. Date: Oct. 9, 2025

(54) SECURE COMMUNICATION METHOD AND DEVICE USING A DETERMINISTICALLY DERIVED IDENTIFIER

(71) Applicant: COMMISSARIAT A L'ENERGIE ATOMIQUE ET AUX ENERGIES ALTERNATIVES, Paris (FR)

(72) Inventors: Christine HENNEBERT, Grenoble Cedex 09 (FR); Quentin JAYET, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/085,032

(22) Filed: Mar. 20, 2025

(30) Foreign Application Priority Data
Apr. 3, 2024 (FR) FR 2403444

(51) Int. Cl. H04L 9/08; G06Q 20/38; G06Q 20/40; H04L 9/00; H04L 9/32

(52) U.S. Cl. CPC H04L 9/0825; G06Q 20/3825; G06Q 20/3827; G06Q 20/3829; G06Q 20/401; H04L 9/3239; H04L 9/3247; H04L 9/50

(57) ABSTRACT

The invention relates to a secure communication method between a transmitting peer (3) and a receiving peer (4) and involving an external actor (2) having a hierarchical deterministic wallet (1) including a pair of master keys kₘₐₛₜₑᵣ and Kₘₐₛₜₑᵣ. The external actor (2) configures (104) the receiving peer (4) by saving an IBE decryption key aDKey[Idⱼ,kₘₐₛₜₑᵣ] in its electronic memory. The external actor (2) configures (105) the transmitting peer (3) by saving an index j of the receiving peer and the master public key Kₘₐₛₜₑᵣ in its electronic memory. The transmitting peer (3) deterministically determines (106) an identifier Idⱼ of the receiving peer, then calculates (107) an IBE encryption key aCKey[Idⱼ,Kₘₐₛₜₑᵣ]. The transmitting peer (3) encrypts (108) a message (60) using the key aCKey[Idⱼ, Kₘₐₛₜₑᵣ] and sends (109) the encrypted message (61) to the receiving peer (4). The receiving peer (4) deciphers (110) the message using the key aDKey[Idⱼ, kₘₐₛₜₑᵣ].

### TECHNICAL FIELD OF THE INVENTION

The subject matter of the invention is a secure communication method. More specifically, the invention relates to a secure communication method using a deterministically derived identifier. This secure communication takes place between devices, referred to as peers in the present document.

The aim of the invention is that of reducing the volume of permanent memory of a peer required to secure the communications of the peer.

### PRIOR ART

Numerous techniques make it possible to secure communications between devices connected by a communication network. The most common ones generally involve the use of public key infrastructure (PKI). However, such techniques necessitate distributing and storing numerous public keys for each device. Identity-Based Encryption (IBE) makes it possible to greatly simplify key management by using a device identifier as a public key, which particularly allows each device to only store identifiers in memory. However, identity-based cryptography has numerous drawbacks, in particular the need for a centralized trusted authority that generates private keys for user devices based on their identifier when these devices need to encrypt a message before it is transmitted. This centralized trust authority is a major compromising point of the security of all devices because it is able to decipher the communications of each of the user devices and spoof their identity in relation to other user devices.

Another technology, which appears to be incompatible with identity-based cryptography, has been described in the context of cryptocurrencies and standardized by “Bitcoin Improvement Proposal BIP32”, also known as the BIP32 standard, followed by BIP39 and BIP44. These are hierarchical deterministic wallets (HDW). They are an advanced form of cryptocurrency wallet, which makes it possible to create an organized structure of accounts and sub-accounts from a single initial seed.

This seed is an entropy source from which keys will be generated and can be used to restore the wallet on another device. Using this seed, a derivation function creates a parent-child structure of keys and addresses hierarchically manner. This means that each key is capable of producing subkeys, which in turn can generate other subkeys, and so on. The first key generated from the seed is called the master key. It is at the top of the hierarchy and will be used to generate child keys. Keys are generated according to specific derivation paths which dictate how to navigate in the key tree structure. This makes it possible to organize accounts for different purposes or cryptocurrencies without mixing funds.

For each address in an HDW wallet, there is a corresponding public key which can be shared and used to receive funds, and a private key which must remain secret and is used to authorize outgoing transactions.

Users can generate numerous addresses from their HDW wallet without having to save each individual private key. A single seed can restore the entire wallet with all its associated keys and transactions.

Hierarchical deterministic wallets are dedicated to securing cryptocurrency transactions, in particular Bitcoin. They are used in decentralized communication networks.

### REFERENCES

“Identity-based encryption from the Weil pairing” by D. Boneh and M. Franklin, SIAM J. of Computing, Vol. 32, No. 3, pp. 586-615, 2003.

### DESCRIPTION OF THE INVENTION

The present invention aims to overcome all or some of the aforementioned drawbacks of the prior art.

To this end, according to a first aspect, the invention relates to a secure communication method between a transmitting peer and a receiving peer. The communication method involves an external actor having a hierarchical deterministic wallet. The hierarchical deterministic wallet includes a pair of asymmetric master keys, consisting of a master private key kₘₐₛₜₑᵣ and a master public key Kₘₐₛₜₑᵣ. The transmitting peer and the receiving peer include an electronic memory and a processing unit. The communication method includes the following steps:
the external actor assigns an index j to the receiving peer in the hierarchical deterministic wallet,
the external actor determines an identifier Idⱼ of the receiving peer deterministically from the index j of the receiving peer and the master public key Kₘₐₛₜₑᵣ,
the external actor generates an IBE decryption key aDKey[Idⱼ,Kₘₐₛₜₑᵣ] from the identifier of the receiving peer Idⱼ and the master private key Kₘₐₛₜₑᵣ,
the external actor configures the receiving peer by saving the IBE decryption key aDKey[Idⱼ,kₘₐₛₜₑᵣ] in the electronic memory of the receiving peer,
the external actor configures the transmitting peer by saving the index j of the receiving peer and the master public key Kₘₐₛₜₑᵣ in the electronic memory of the transmitting peer,
the transmitting peer deterministically determines the identifier Idⱼ of the receiving peer from the index j of the receiving peer and the master public key Kₘₐₛₜₑᵣ,
the transmitting peer calculates an IBE encryption key aCKey[Idⱼ, Kₘₐₛₜₑᵣ] from the identifier of the receiving peer Idⱼ and the master public key Kₘₐₛₜₑᵣ,
the transmitting peer encrypts a message using the IBE encryption key aCKey[Idⱼ, Kₘₐₛₜₑᵣ],
the transmitting peer sends the encrypted message to the receiving peer,
the receiving peer deciphers the encrypted message using the IBE decryption key aDKey[Idⱼ, Kₘₐₛₜₑᵣ].

Peer means a device configured to communicate with other similar devices.

Hierarchical deterministic wallet means a system for generating cryptographic keys from an initial seed deterministically. The initial seed makes it possible to generate parent keys, which are subsequently used to derive child keys. The cryptographic keys from a hierarchical deterministic wallet do not need to be saved, they can be regenerated identically for each use.

An external actor means a peer device manufacturer or an entity in charge of configuring the peer devices to make up the members of a decentralized communication network.

Such arrangements allow, when the steps performed by the external actor are performed offline (the peers are not connected to a communication network), secure communication between the receiving peer and the transmitting peer requiring the storage of only a few cryptographic elements in the electronic memory of the peers. Indeed, the identifier and the encryption key are calculated by the transmitting peer for the transmission of a message and therefore do not need to be stored in the electronic memory of the transmitting peer.

In particular implementations, the invention may further include one or more of the following features, taken individually or according to any technically possible combinations.

According to one embodiment, the steps of deterministically determining the identifier Idⱼ are carried out using a derivation function using a hash function HMAC-SHA512.

According to one embodiment, the communication method includes the following additional steps:
the transmitting peer calculates a public key Kᵢₕ from a private key Kᵢₕ,
the transmitting peer discloses the public key Kᵢₕ to the receiving peer,
the transmitting peer generates a message signature using the encrypted message and the private key Kᵢₕ,
the transmitting peer sends the message signature to the receiving peer,
the receiving peer verifies the message signature using the public key Kᵢₕ and the encrypted message.

Such arrangements allow the receiving peer to verify the authenticity of the message received.

According to one embodiment, the transmitting peer includes a hardware security component and the private key Kᵢₕ is generated in the hardware security component.

The hardware security component makes it possible to further secure the private key of the transmitting peer and thus further limit in particular the risk of the identity of the transmitting peer being spoofed.

According to one embodiment, the transmitting peer and the receiving peer are peers of a peer network sharing a distributed registry and the communication method includes the following additional steps:
the transmitting peer generates a hash of the encrypted message,
the transmitting peer is authenticated with the distributed registry using a private key Kᵢₕ,
the transmitting peer publishes a transaction including the identifier of the receiving peer and the hash of the encrypted message in the distributed registry,
the receiving peer verifies that the hash of the encrypted message published in the distributed registry matches the encrypted message received.

Peer network means several devices connected remotely by, for example, an Internet or GSM network or a combination of several remote connection technologies. Each device, known as peer, of the peer network can comprise at least one processing unit, a memory and a communication module.

Distributed registry means a decentralized registry or log or ledger, shared between the peers of the peer network, optionally replicated by each peer of the peer network and wherein operations or publications are saved in a certain order and cannot be modified once saved. A decentralized registry can be embodied using a technology such as a blockchain or a decentralized database or a “Directed Acyclic Graph”, for example.

Using a distributed register allows the receiving peer to verify the authenticity of the message without needing to store the public key of the transmitting peer in memory.

According to one embodiment, the distributed registry is a distributed blockchain registry and the blockchain comprises a smart contract transmitting a notification to the receiving peer, the notification comprising the hash of the encrypted message.

Using a blockchain smart contract to transmit the hash of the encrypted message makes it possible to trigger the transmission of the hash by publishing the transaction in the registry. The receiving peer will not need to retrieve the hash from the registry to verify the authenticity of the message.

According to one embodiment, the external actor generates the private key Kᵢₕ and configures the transmitting peer by saving the private key kin in the electronic memory of the transmitting peer.

According to one embodiment, the private key kin is an enhanced extended child private key generated from the master private key Kₘₐₛₜₑᵣ using an index ih equal to the sum of an integer index i and 2³¹.

When the private key kin is generated according to the deterministic generation scheme standardized by “Bitcoin Improvement Proposal BIP32”, the use of an index greater than 2³¹ makes it possible to prevent a third party from deducing the master private key Kₘₐₛₜₑᵣ from the master public key Kₘₐₛₜₑᵣ and the private key Kᵢₕ.

According to a second aspect, the invention relates to a peer device comprising an electronic memory and a processing unit. The processing unit is configured to carry out the following steps, by executing instructions contained in the electronic memory:
deterministically determining an identifier Idⱼ of a receiving peer from an index j of the receiving peer and a master public key Kₘₐₛₜₑᵣ,
calculating an IBE encryption key aCKey[Idⱼ, Kₘₐₛₜₑᵣ] from the identifier of the receiving peer Idⱼ and the master public key Kₘₐₛₜₑᵣ,
encrypting a first message using the IBE encryption key aCKey[Idⱼ, Kₘₐₛₜₑᵣ],
sending the first encrypted message to the receiving peer,
deciphering a second encrypted message using an IBE decryption key aDKey[Idᵢ, Kₘₐₛₜₑᵣ].

Such arrangements allow the peer device to implement the secure communication method according to the invention as a receiving peer and as a transmitting peer.

According to one embodiment, the device also includes a hardware security component, and the hardware security component is configured to carry out the following steps:
deterministically determining an identifier Idⱼ of a receiving peer from an index j of the receiving peer and a master public key Kₘₐₛₜₑᵣ,
calculating an IBE encryption key aCKey[Idⱼ, Kₘₐₛₜₑᵣ] from the identifier of the receiving peer Idⱼ and the master public key Kₘₐₛₜₑᵣ,
deciphering an encrypted message using an IBE decryption key aDKey[Idᵢ, Kₘₐₛₜₑᵣ].

The hardware security component makes it possible to further increase the security of the communications of the peer device by reducing the risk of a third party obtaining one of the sensitive cryptographic elements that are the decryption key, the master public key Kₘₐₛₜₑᵣ and the identifier of the receiving peer.

### PRESENTATION OF THE FIGURES

The invention will be better understood upon reading the following description, given as a non-limiting example, and made with reference to the figures:

FIG. 1 a schematic representation of an example of the method according to the first aspect of the invention,

FIG. 2 a schematic representation of examples of identifier determination,

FIG. 3 a schematic representation of an example of an embodiment of the method according to the first aspect of the invention,

FIG. 4 a schematic representation of an example of another embodiment of the method according to the first aspect of the invention,

FIG. 5 a schematic representation of an example of the peer device according to the second aspect of the invention.

In these figures, identical references from one figure to another refer to identical or similar elements. For clarity, the represented elements are not necessarily to the same scale, unless stated otherwise.

### DETAILED DESCRIPTION OF THE INVENTION

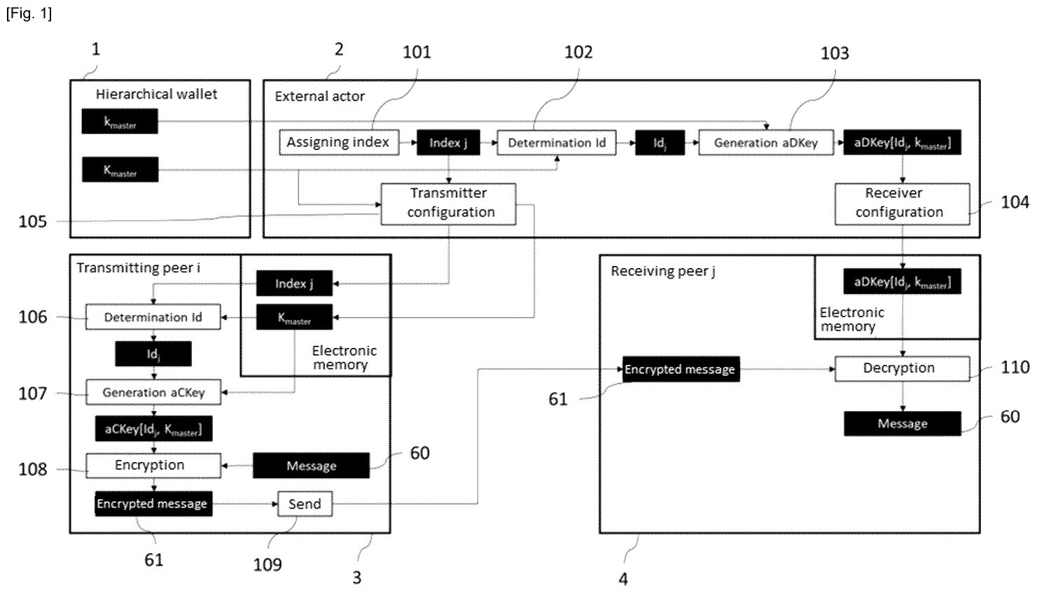

FIG. 1 is a schematic representation of an example of the method according to the first aspect of the invention. An external actor 2 is represented. This external actor 2 may be a peer device manufacturer, supplier or user who configures the peer devices according to the invention prior to their commissioning. The external actor 2 has a hierarchical deterministic wallet 1. The hierarchical deterministic wallet 1 includes a master private key kₘₐₛₜₑᵣ and a master public key Kₘₐₛₜₑᵣ derived from an initial seed. The master public key Kₘₐₛₜₑᵣ may for example be calculated from the master private key kₘₐₛₜₑᵣ according to the operation on the elliptic curve:

$${K}_{master} = {k}_{master} G ( mod n ) \qquad [ Math . 1 ]$$

The external actor 2 performs several steps aimed at prior configuration of a transmitting peer 3 and a receiving peer 4. The external actor 2 assigns 101 an index, annotated index j in the present document and in the figures, to the receiving peer 4. From the index j and the master public key Kₘₐₛₜₑᵣ, it determines 102 an identifier of the receiving peer annotated Idⱼ. This determination is deterministic, i.e. from the same index and the same master public key Kₘₐₛₜₑᵣ, the determined identifier will always be the same. Then, the external actor 2 generates 103 a decryption key aDKey[Idⱼ, kₘₐₛₜₑᵣ] for the receiving peer 4 using the identifier of the receiving peer and the master private key kₘₐₛₜₑᵣ. The decryption key aDKey[Idⱼ, kₘₐₛₜₑᵣ] may be generated according to an IBE generation scheme of the prior art. The external actor 2 configures 104 the receiving peer 4 by saving the decryption key aDKey[Idⱼ, kₘₐₛₜₑᵣ] in an electronic memory of the receiving peer. The external actor 2 also configures 105 the transmitting peer 3 by saving Index j of the receiving peer 4 and the master public key Kₘₐₛₜₑᵣ in an electronic memory of the transmitting peer.

The transmitting peer 3 may then communicate securely to the receiving peer 4 via a communication network. This communication takes place as follows: The transmitting peer determines 106 the identifier Idⱼ of the receiving peer 4 from the index j and the master public key. It calculates 107 an encryption key aCKey[Idⱼ, Kₘₐₛₜₑᵣ] from the identifier of the receiving peer 4 and the master public key Kₘₐₛₜₑᵣ. This encryption key aCKey[Idⱼ, Kₘₐₛₜₑᵣ] is calculated according to an IBE scheme of the prior art making it possible to match the encryption key aCKey[Idⱼ, Kₘₐₛₜₑᵣ] to the decryption key aDKey[Idⱼ, kₘₐₛₜₑᵣ]. The transmitting peer encrypts 108 a message 60 using the key aCKey[Idⱼ, Kₘₐₛₜₑᵣ] and sends 109 the encrypted message 61 to the receiving peer 4. The receiving peer 4 will then decipher 110 the encrypted message 61 received.

The implementation of this method allows the transmitting peer to secure its messages to the receiving peer by only needing to store the index of the receiving peer and the master public key permanently in its electronic memory. A small volume of permanent electronic memory is therefore needed to secure exchanges between peers using the method according to the invention.

The method according to the invention may, for example, be used to secure communications between the drones of a drone fleet. In this example, a drone will act as a peer in the method. As drones are typically devices with a compact onboard electronic memory, the method according to the invention is therefore particularly advantageous for securing their communications.

According to one embodiment, the determinations 102, 106 of the identifier Idⱼ of the receiving peer are carried out using a derivation function using a hash function HMAC-SHA512. HMAC means “Hash-based Message Authentication Code”. SHA512 represents the specific hash algorithm used in this process, which is part of the SHA-2 (Secure Hash Algorithm 2) family and produces a 512-bit digest.

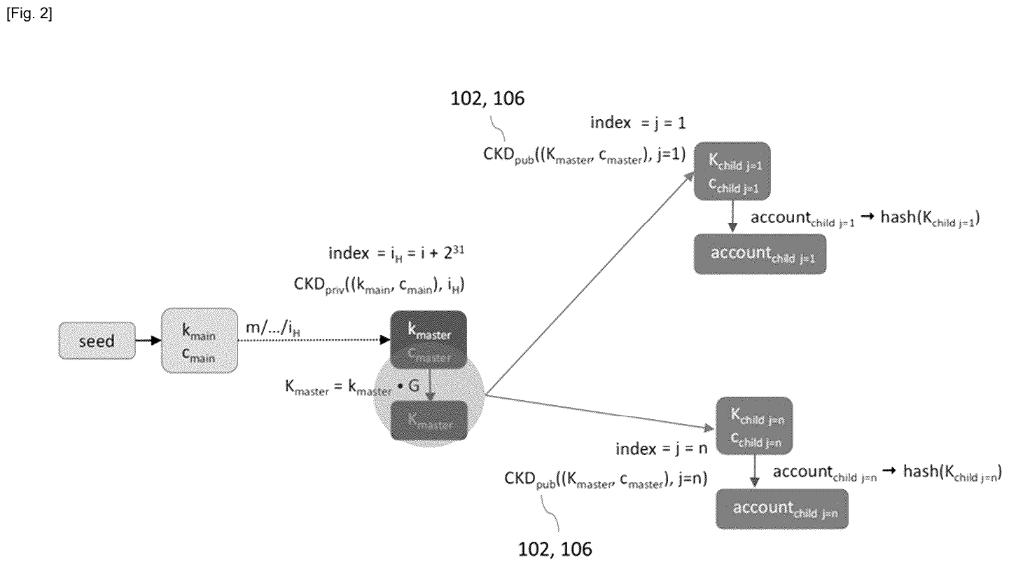

FIG. 2 is a schematic representation of an example of generating the identifier Idⱼ of the receiving peer 4. In these examples, a string of code cₘₐₛₜₑᵣ is used in addition to the master public key Kₘₐₛₜₑᵣ and the index j to determine 102, 106 a child public key K_{child j} and a string of code c_{child j}. The string of code cₘₐₛₜₑᵣ makes it possible to increase the entropy of the cryptographic elements generated. The child public key K_{child j} could be generated only from the master public key Kₘₐₛₜₑᵣ and the index j. The child public key K_{child j} can also be used to generate an account name account_{child j}.

According to one embodiment, the identifier of the receiving peer Idⱼ is the child public key K_{child j}.

According to one embodiment, the identifier Idⱼ is the string of code c_{child j}.

According to one embodiment, the identifier Idⱼ is the account name account_{child j}.

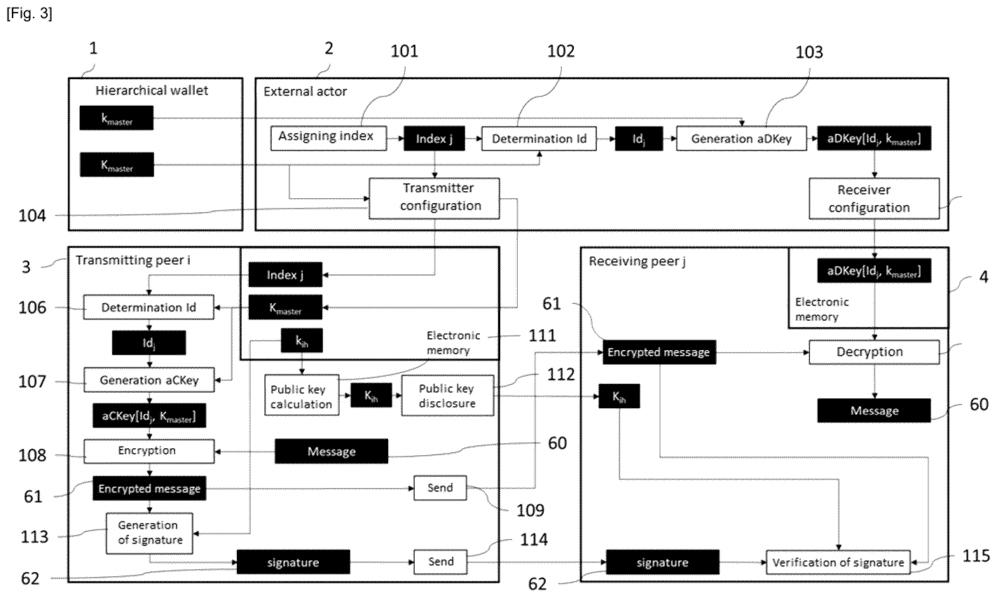

FIG. 3 a schematic representation of an example of an embodiment of the method according to the first aspect of the invention. The steps of the embodiment described by [FIG. 1] are present. Additionally, in this embodiment, the transmitting peer 3 also has a private key kᵢₕ in its electronic memory. In order to prove the authenticity of the message 60 sent to the receiving peer 4, the transmitting peer 3 calculates 111 a public key Kᵢₕ matching the private key kᵢₕ. The keys Kᵢₕ and kᵢₕ are a pair of asymmetric keys. The public key Kᵢₕ is used to verify that a signature was generated using the private key kᵢₕ. The transmitting peer then discloses 112 its public key Kᵢₕ. The receiving peer may temporarily or permanently save the public key Kᵢₕ of the transmitting peer. Once the message 60 is encrypted 108 by the transmitting peer 3 using the encryption key aCKey[Idⱼ, Kₘₐₛₜₑᵣ], the transmitting peer 3 generates 113 a signature 62 of the encrypted message 61 using its private key kᵢₕ. The transmitting peer 3 sends 114 the signature 62 to the receiving peer 4. The signature 62 may, for example, be sent together with sending 109 the encrypted message 61 by concatenating the encrypted message 61 and the signature 62 in a single message. The receiving peer 4 may then verify 115 the signature 62 using the public key Kᵢₕ and the encrypted message, this verification may be performed according to a standard asymmetric scheme of the prior art and makes it possible to ensure that the signature was generated using the private key kᵢₕ and that it matches the encrypted message 61. In this way, the receiving peer may ensure the authenticity of the encrypted message 61.

According to one embodiment, the transmitting peer includes a hardware security component which makes it possible to generate the private key kᵢₕ and will optionally host the generation of the corresponding public key Kᵢₕ. Using a hardware security component for generating a pair of asymmetric keys increases peer security by significantly reducing the risk of identity spoofing of a peer or corruption of a peer. The hardware security component is for example, a TPM, or Trusted Platform Module, component using the TPM 1.2 or TPM 2 protocol.

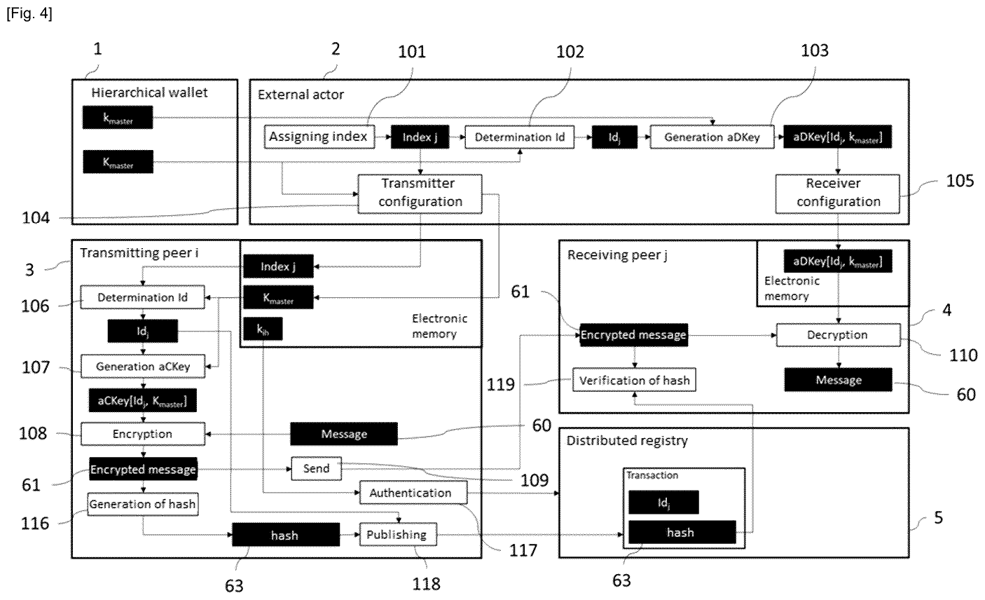

FIG. 4 a schematic representation of an example of another embodiment of the method according to the first aspect of the invention. The steps of the method according to the invention described in [FIG. 1] are also represented. In this embodiment, the electronic memory of the transmitting peer 3 also includes a private key kᵢₕ. The transmitting peer 3 and the receiving peer are members of a peer network, and share a distributed registry 5. The distributed registry 5 may optionally be decentralized and/or replicated by each peer of the peer network. Operations or publications are saved in a certain order in the distributed registry 5 and can no longer be modified once saved. The distributed registry 5 can be embodied using a technology such as for example a blockchain or a decentralized database or a “Directed Acyclic Graph”.

The transmitting peer 4 is authenticated 117 with the distributed registry 5 using its private key kᵢₕ. It generates 116 a hash 63 of the encrypted message 61 according to, for example, a hash scheme HMAC. The transmitting peer 4 then publishes 118 a transaction in the distributed registry 5, the transaction including the hash 63 and the identifier Idⱼ of the receiving peer 4. On receipt of the encrypted message 61, the receiving peer can verify 119 that the hash 63 matches the encrypted message 61. As authentication 117 of the transmitting peer with the distributed registry 5 is needed for publishing 118, the receiving peer will be able to ensure the authenticity of the encrypted message 61 by verifying the correspondence between the hash 63 and the encrypted message 61. Using the distributed registry 5 makes it possible to avoid the step of calculating and publishing the public key Kᵢₕ while retaining the possibility of verifying the authenticity of the messages.

According to one embodiment, the distributed registry 5 is a registry, also known as ledger, of a blockchain such as for example an Ethereum chain. The blockchain includes a smart contract which transmits the hash 63 of the encrypted message 61 by a notification to the receiving peer triggered by publishing 118 in the distributed registry 5.

The smart contract may take the following form, for example:

| // SPDX-License-Identifier: UNLICENSED | |
|---|---|
| pragma solidity \hat{ }0.8.0; | |
| contract registration { | |
| address receiver; | // receiving peer identifier |
| address owner; | // external actor identifier |
| uint256 hash; | |

```
  mapping (address => hash) public attestation;
  event Attest (address _receiver, uint256 _hash) ;
  constructor ( ) {
    msg.sender = owner;
}
  function attest(address _receiver, uint256 _hash) public {
    require(status[msg.sender] == LEGITIMATE) ;
    attestation[_receiver] = _hash;
    emit Attest(_receiver, _hash) ;
  }
```

The transmitting peer builds a transaction to the smart contract attest function which includes the hash of the previously encrypted message. Then, it transmits, on the one hand, the encrypted message to the receiving peer via the peer-to-peer communication channel, and on the other, the transaction to the blockchain registry where the smart contract was previously deployed.

The receiving peer is notified by the smart contract that it has been sent a message. The notification includes the hash 63 of this encrypted message 61. On receipt of the message, it can verify that the hash matches, before performing decryption 110.

If desired, the receiving peer can also consult the blockchain to know the account address, generally the identifier, of the transmitting peer 4. The use of a blockchain guarantees by design that the digital signature of the transaction is valid and that the key used matches the identifier of the transmitting account.

According to one embodiment not shown, the external actor 2 also configures the transmitting peer 3 by saving the private key kᵢₕ in the electronic memory of the transmitting peer 3. The private key kᵢₕ may be an enhanced extended child private key generated from the master private key Kₘₐₛₜₑᵣ using an index ih equal to the sum of an integer index i and 2³¹. The enhanced extended child private key can be generated according to the generation scheme shown in [FIG. 2]. This deterministic generation scheme, standardized by “Bitcoin Improvement Proposal BIP32”, with the use of an index greater than 2³¹ makes it possible to prevent a third party from deducing the master private key Kₘₐₛₜₑᵣ from the master public key Kₘₐₛₜₑᵣ and the private key Kᵢₕ. The security of peer-to-peer communications is therefore enhanced further.

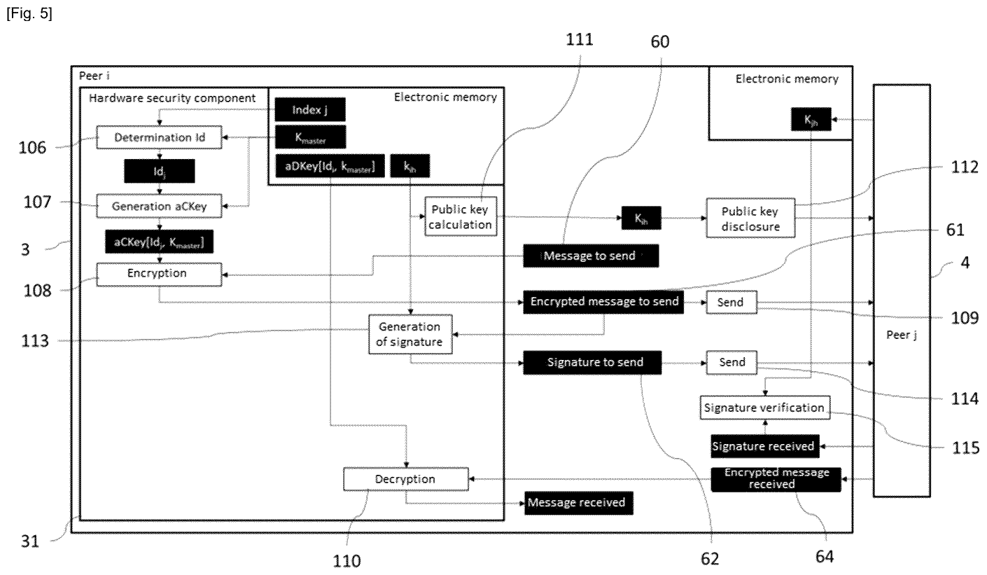

FIG. 5 is a schematic representation of an example of the peer device according to the second aspect of the invention. The peer device may implement the method according to the first aspect of the invention as a receiving peer 4 and as a transmitting peer 3. The peer device includes a processing unit, not shown, configured to carry out several steps of the method according to the first aspect of the invention by executing instructions contained in an electronic memory.

The peer device of index i has been previously configured to include an index j of another peer device, a master public key Kₘₐₛₜₑᵣ and an IBE decryption key aDKey[Idᵢ, Kₘₐₛₜₑᵣ] in its electronic memory. The peer device of index i deterministically determines 106 the identifier Idⱼ of the peer device of index j from the index j and the master public key Kₘₐₛₜₑᵣ. Then the peer device of index i calculates 107 an IBE encryption key aCKey[Idⱼ, Kₘₐₛₜₑᵣ] according to an identity-based cryptography scheme using the identifier Idⱼ and the master public key Kₘₐₛₜₑᵣ. The peer device of index i encrypts 108 a first message 60, intended for the peer device of index j, using the IBE encryption key aCKey[Idⱼ, Kₘₐₛₜₑᵣ] then sends 109 the first encrypted message 61 to the peer device of index j. The peer device of index i may also receive a second encrypted message from the peer of the peer device of index j and decipher 110 this second encrypted message 64 using the IBE decryption key aDKey[Idᵢ, Kₘₐₛₜₑᵣ].

According to one embodiment, the messages exchanged between the peer devices may also be authenticated on their receipt. This authentication will be carried out before the decryption of the message in this way, if the message is not authentic, the computing resources required for decryption will be saved. The peer device i may have a private key Kᵢₕ in its electronic memory, from this key, the peer device i calculates 111 a corresponding public key Kᵢₕ, the keys Kᵢₕ and Kᵢₕ forming a pair of asymmetric keys, and discloses 112 the public key Kᵢₕ. When preparing to send a message 60, once the message 60 is encrypted, the peer device i will be able to generate 113 a signature 62 of the encrypted message 61 using the private key kᵢₕ and send 114 the signature 62 with the encrypted message 61. As a receiving peer, the peer device i may receive and save a public key Kⱼₕ disclosed by the peer device j. The peer device i may receive a second encrypted message 64 from the peer device j and a signature matching the second encrypted message 64. Before deciphering the second encrypted message 64, the peer device i verifies 115 the signature received using the public key Kⱼₕ of the peer device j. Verifying this signature makes it possible to ensure that it was generated using a private key kⱼₕ matching the public key Kⱼₕ and that it was generated from the second encrypted message 64. In addition, verifying 115 the signature may also make it possible to ensure the integrity of the encrypted message 64. Message integrity means that the message was not modified between the generation of the corresponding signature and the verification of the corresponding signature.

The peer device may also include a hardware security component 31, the hardware security component 31 is configured to carry out part of the steps carried out by the peer device. The hardware security component may also be used to store cryptographic elements, such as the indexes of other peer devices associated with the peer device i, the master public key Kₘₐₛₜₑᵣ, the decryption key aDKey[Idᵢ,kₘₐₛₜₑᵣ] and the private key kᵢₕ, in memory. The hardware security component is configured to determine 106 the identifier Id of the peer device of index j, to calculate 107 the IBE encryption key aDKey[Idⱼ, Kₘₐₛₜₑᵣ], to encrypt 108 a message intended for the peer j and to decipher 110 an encrypted message received. The hardware security component may also be configured to calculate 111 the public key Kᵢₕ and generate 113 the signature of the encrypted message.

The hardware security component will make it possible to secure the communications of the peer device further by adding an additional barrier preventing third parties from observing cryptographic steps and elements required to secure the communications.

According to one embodiment not shown, the peer device i may also implement the embodiment of the method according to the invention involving the use of a distributed registry. The peer device i will be able to be authenticated 117 with the distributed registry and publish 118 transactions in order to allow verification of the authenticity and integrity of encrypted messages sent.

1. A secure communication method between a transmitting peer (3) and a receiving peer (4), involving an external actor (2) having a hierarchical deterministic wallet (1), the hierarchical deterministic wallet (1) includes a pair of asymmetric master keys, consisting of a master private key kₘₐₛₜₑᵣ and a master public key Kₘₐₛₜₑᵣ, the transmitting peer (3) and the receiving peer (4) include an electronic memory and a processing unit, the communication method includes the following steps:
the external actor (2) assigns (101) an index j to the receiving peer (4) in the hierarchical deterministic wallet (1),
the external actor (2) determines (102) an identifier Idⱼ of the receiving peer (4) deterministically from the index j of the receiving peer (4) and the master public key Kₘₐₛₜₑᵣ,
the external actor (2) generates (103) an IBE decryption key aDKey[Idⱼ,kₘₐₛₜₑᵣ] from the identifier of the receiving peer Idⱼ and the master private key kₘₐₛₜₑᵣ,
the external actor (2) configures (104) the receiving peer (4) by saving the IBE decryption key aDKey[Idⱼ,kₘₐₛₜₑᵣ] in the electronic memory of the receiving peer,
the external actor (2) configures (105) the transmitting peer (3) by saving the index j of the receiving peer and the master public key Kₘₐₛₜₑᵣ in the electronic memory of the transmitting peer,
the transmitting peer (3) deterministically determines (106) the identifier Idⱼ of the receiving peer from the index j of the receiving peer and the master public key Kₘₐₛₜₑᵣ,
the transmitting peer (3) calculates (107) an IBE encryption key aCKey[Idⱼ,Kₘₐₛₜₑᵣ] from the identifier of the receiving peer Idⱼ and the master public key Kₘₐₛₜₑᵣ,
the transmitting peer (3) encrypts (108) a message (60) using the IBE encryption key aCKey[Idⱼ, Kₘₐₛₜₑᵣ],
the transmitting peer (3) sends (109) the encrypted message (61) to the receiving peer (4),
the receiving peer (4) deciphers (110) the encrypted message (61) using the IBE decryption IBE key aDKey[Idⱼ, kₘₐₛₜₑᵣ].

2. The method according to claim 1, wherein the steps (102, 106) of deterministically determining the identifier Idⱼ are carried out using a derivation function using a hash function HMAC-SHA512.

3. The method according to claim 1, including the following additional steps:
the transmitting peer (3) calculates (111) a public key Kᵢₕ from a private key kᵢₕ,
the transmitting peer (3) discloses (112) the public key Kᵢₕ to the receiving peer (4),
the transmitting peer (3) generates (113) a signature (62) of the message using the encrypted message (61) and the private key Kᵢₕ,
the transmitting peer (3) sends (114) the message signature (62) to the receiving peer (4),
the receiving peer (4) verifies (115) the message signature (62) using the public key Kᵢₕ and the encrypted message (51).

4. The method according to claim 3, wherein the transmitting peer (3) includes a hardware security component (31) and wherein the private key kᵢₕ is generated in the hardware security component (31).

5. The method according to claim 1, wherein the transmitting peer (3) and the receiving peer (4) are peers of a peer network sharing a distributed registry (5) and wherein the following additional steps are carried out:
the transmitting peer (3) generates (116) a hash (63) of the encrypted message (61),
the transmitting peer (3) is authenticated (117) with the distributed registry (5) using a private key Kᵢₕ,
the transmitting peer (3) publishes (118) a transaction including the identifier of the receiving peer and the hash (63) of the encrypted message (61) in the distributed registry (5),
the receiving peer (4) verifies (119) that the hash (63) of the encrypted message published in the distributed registry (5) matches the encrypted message (61) received.

6. The method according to claim 5, wherein the distributed registry (5) is a distributed blockchain registry and wherein the blockchain comprises a smart contract transmitting a notification to the receiving peer (4), the notification comprising the hash (63) of the encrypted message.

7. The method according to claim 3, wherein the external actor (2) generates the private key kᵢₕ and wherein the external actor (2) configures the transmitting peer by saving the private key Kᵢₕ in the electronic memory of the transmitting peer.

8. The method according to claim 7, wherein the private key Kᵢₕ is an enhanced extended child private key generated from the master private key kₘₐₛₜₑᵣ using an index ih equal to the sum of an integer index i and 2³¹.

9. A peer device (3, 4) including an electronic memory and a processing unit, the processing unit is configured to carry out the following steps, by executing instructions contained in the electronic memory:
deterministically determining (106) an identifier Idⱼ of a receiving peer (3, 4) from an index j of the receiving peer (3, 4) and a master public key Kₘₐₛₜₑᵣ,
calculating (107) an IBE encryption key aCKey[Idⱼ,Kₘₐₛₜₑᵣ] from the identifier of the receiving peer Idⱼ and the master public key Kₘₐₛₜₑᵣ,
encrypting (108) a first message (60) using the IBE encryption key aCKey[Idⱼ, Kₘₐₛₜₑᵣ],
sending (109) the first encrypted message (61) to the receiving peer (3, 4),
deciphering (110) a second encrypted message (64) using an IBE decryption key aDKey[Idᵢ, kₘₐₛₜₑᵣ].

10. The device according to claim 9, also including a hardware security component (31), and wherein the hardware security component (31) is configured to carry out the following steps:
deterministically determining (106) an identifier Idⱼ of a receiving peer (3, 4) from an index j of the receiving peer (3, 4) and a master public key Kₘₐₛₜₑᵣ,
calculating (107) an IBE encryption key aCKey[Idⱼ,Kₘₐₛₜₑᵣ] from the identifier of the receiving peer Idⱼ and the master public key Kₘₐₛₜₑᵣ,
deciphering (110) an encrypted message (64) using an IBE decryption key aDKey[Idᵢ, kₘₐₛₜₑᵣ].
